(19) United States
(12) Patent Application Publication
(10) Pub. No.: US 2019/0191434 A1
(43) Pub. Date: Jun. 20, 2019

(54) DOWNLINK CONTROL CHANNEL SEARCH SPACE DEFINITION FOR REDUCED PROCESSING TIME

(71) Applicant: Nokia Technologies Oy, Espoo (FI)

(72) Inventors: Klaus Hugl, Wien (AT); Timo Erkki Lunttila, Espoo (FI); Karol Schober, Helsinki (FI)

(21) Appl. No.: 16/318,867

(22) PCT Filed: Jul. 12, 2017
(86) PCT No.: PCT/IB2017/054220

§ 371 Date: Jan. 18, 2019

Related U.S. Application Data
(60) Provisional application No. 62/365,101, filed on Jul. 21, 2016.

(51) Int. Cl. H04W 72/04

(52) U.S. Cl. CPC H04W 72/0446; H04W 84/042; H04W 72/042

(57) ABSTRACT

A radio network sends to a user equipment (UE) an indication that reduced processing time associated with a reduced search space is operational for the UE. The reduced search space is a sub-set of a larger search space associated with a non-reduced processing time. The network sends to the UE within the reduced search space downlink control information (DCI) in subframe N that allocates to the UE a radio resource. If the allocated radio resource is uplink, the network receives uplink data from the UE on the allocated radio resource in a subframe spaced from the subframe N an amount of the reduced processing time (N+reduced processing time); and/or if the allocated radio resource is downlink the network sends downlink data to the UE on the allocated radio resource in subframe N and receives from the UE in reply feedback (ACK/NACK) signaling in a subframe N+reduced processing time.

### TECHNOLOGICAL FIELD

The described invention relates to wireless communications, and more particularly to defining blind decoding search spaces in radio systems so as to enable shorter search times which enables a shorter minimum processing delay between one signaling event and its earliest response. For example, in the LTE radio access technologies the processing delay has typically been N+4, meaning a signaling event such as a resource allocation/PDCCH in subframe N could allocate uplink resources in a subframe no earlier than subframe N+4. In the same way, the HARQ-Ack feedback for a downlink data/PDSCH received in subframe N could not be in the uplink direction sent earlier than in subframe N+4.

### BACKGROUND

Wireless radio access technologies continue to be improved to handle increased data volumes and larger numbers of subscribers. The 3GPP organization is developing one such improvement referred to as LTE-Advanced Pro which is to become part of 3GPP LTE Rel-13/14. In Rel-13 there was a study item document RP-150465 by Ericsson and Huawei entitled “New SI proposal: Study on Latency reduction techniques for LTE” [3GPP TSG RAN Meeting #67; Shanghai, China; 9-12 Mar. 2015] which was carried out in the first half of year 2016 and which concluded that a reduction in processing time would be necessary in order to improve the physical layer radio latency.

Further in this regard a follow-up work item was approved [document RP-161299 by Ericsson entitled “new Work item on shortened TTI and processing time for LTE”; 3GPP TSG RAN Meeting #72; Busan, Korea; 13-16 Jun. 2016] which listed an objective of a shorter TTI operation with reduced processing as well as also enabling reduced processing time for legacy 1 ms TTI channel designs. More specifically, RP-161299 states:
For Frame structure types 1, 2 and 3 for legacy 1 ms TTI operation: [RAN1, RAN2, RAN4] (until RAN1#88).
   Specify support for a reduced minimum timing compared to legacy operation according to [2] between UL grant and UL data and between DL data and DL HARQ feedback for legacy 1 ms TTI operation, reusing the Rel-14 PDSCH/(E)PDCCH/PUSCH/PUCCH channel design [RAN1, RAN2].
      This applies at least for the case of restricted maximum supported transport block sizes for PDSCH and/or PUSCH when the reduced minimum timing is in operation, and if agreed by RAN1 for the case of unrestricted maximum supported transport block sizes.
      Specify support for a reduced maximum TA to enable processing time reductions.
      Note that the size of the reduction in minimum timing may be different between UL and DL cases.
      Study any impact on CSI feedback and processing time, and if needed, specify necessary modifications (not before RAN1 #86bis).
      Study and specify, if agreed by RAN1, asynchronous HARQ for PUSCH with reduced processing time [RAN1, RAN2].

The above document shows that the processing of DL control information incorporates a significant part of the processing time required by the UE. Embodiments of these teachings address how to reduce that minimum processing delay/latency, at least in some circumstances that can be unequivocally identified by the network to the UE. The mechanism by which these teachings enable this result is to re-define the search space in which the UE looks to blind-decode the signaling it expects to receive from the network.

These aspects and others are detailed further below with particularity.

### SUMMARY

According to a first aspect of the invention there is a method comprising: a) sending to a user equipment (UE) an indication that reduced processing time that is associated with a reduced search space is operational for the UE, wherein the reduced search space is a sub-set of a larger search space associated with a non-reduced processing time; b) sending to the UE within the reduced search space downlink control information (DCI) in subframe N that allocates to the UE a radio resource; and thereafter c1) if the allocated radio resource is uplink, receiving uplink data from the UE on the allocated radio resource in a subframe spaced from the subframe N an amount of the reduced processing time; and/or c2) if the allocated radio resource is downlink, sending downlink data to the UE on the allocated radio resource in subframe N and receiving from the UE in reply feedback signaling in a subframe spaced from the subframe N an amount of the reduced processing time. In a particular embodiment there is a computer readable memory tangibly storing a computer program that when executed causes a radio access node to perform this method.

According to a second aspect of the invention there is an apparatus comprising at least one processor and at least one memory tangibly storing a computer program. In this aspect the at least one processor is configured with the at least one memory and the computer program to cause the apparatus to perform actions comprising: a) send to a user equipment (UE) an indication that reduced processing time that is associated with a reduced search space is operational for the UE, wherein the reduced search space is a sub-set of a larger search space associated with a non-reduced processing time; b) send to the UE within the reduced search space downlink control information (DCI) in subframe N that allocates to the UE a radio resource; and thereafter c1) if the allocated radio resource is uplink, receive uplink data from the UE on the allocated radio resource in a subframe spaced from the subframe N an amount of the reduced processing time; and/or c2) if the allocated radio resource is downlink, send downlink data to the UE on the allocated radio resource in subframe N and receive from the UE in reply feedback signaling in a subframe spaced from the subframe N an amount of the reduced processing time.

According to a third aspect of the invention there is an apparatus comprising computing means and radio communication means for: a) sending to a user equipment (UE) an indication that reduced processing time that is associated with a reduced search space is operational for the UE, wherein the reduced search space is a sub-set of a larger search space associated with a non-reduced processing time; b) sending to the UE within the reduced search space downlink control information (DCI) in subframe N that allocates to the UE a radio resource; and thereafter c1) if the allocated radio resource is uplink, receiving uplink data from the UE on the allocated radio resource in a subframe spaced from the subframe N an amount of the reduced processing time; and/or c2) if the allocated radio resource is downlink, sending downlink data to the UE on the allocated radio resource in subframe N and receiving from the UE in reply feedback signaling in a subframe spaced from the subframe N an amount of the reduced processing time. In a particular embodiment of this aspect the computing means comprises at least one processor and at least one memory tangibly storing a computer program; and the radio communication means comprises a transmitter and a receiver.

According to a fourth aspect of the invention there is a method comprising: a) receiving from a radio access node an indication that reduced processing time that is associated with a reduced search space is operational for a user equipment (UE), wherein the reduced search space is a sub-set of a larger search space associated with a non-reduced processing time; b) receiving from the radio access node downlink control information (DCI) in a subframe N that allocates a radio resource; and thereafter c1) if the allocated radio resource is uplink, sending uplink data to the radio access node in a subframe spaced from the subframe N an amount of the reduced processing time, and/or c2) if the allocated radio resource is downlink, receiving downlink data from the radio access node on the allocated radio resource in subframe N and sending to the radio access node in reply feedback signaling in a subframe spaced from the subframe N an amount of the reduced processing time. In a particular embodiment there is a computer readable memory tangibly storing a computer program that when executed causes a user equipment (UE) to perform this method.

According to a fifth aspect of the invention there is an apparatus comprising at least one processor and at least one memory tangibly storing a computer program. In this aspect the at least one processor is configured with the at least one memory and the computer program to cause the apparatus to perform actions comprising: a) receive from a radio access node an indication that reduced processing time that is associated with a reduced search space is operational for a user equipment (UE), wherein the reduced search space is a sub-set of a larger search space associated with a non-reduced processing time; b) receive from the radio access node downlink control information (DCI) in a subframe N that allocates a radio resource; and thereafter c1) if the allocated radio resource is uplink, send uplink data to the radio access node in a subframe spaced from the subframe N an amount of the reduced processing time, and/or c2) if the allocated radio resource is downlink, receive downlink data from the radio access node on the allocated radio resource in subframe N and send to the radio access node in reply feedback signaling in a subframe spaced from the subframe N an amount of the reduced processing time.

According to a sixth aspect of the invention there is an apparatus comprising computing means and radio communication means for: a) receiving from a radio access node an indication that reduced processing time that is associated with a reduced search space is operational for a user equipment (UE), wherein the reduced search space is a sub-set of a larger search space associated with a non-reduced processing time; b) receiving from the radio access node downlink control information (DCI) in a subframe N that allocates a radio resource; and thereafter c1) if the allocated radio resource is uplink, sending uplink data to the radio access node in a subframe spaced from the subframe N an amount of the reduced processing time, and/or c2) if the allocated radio resource is downlink, receiving downlink data from the radio access node on the allocated radio resource in subframe N and sending to the radio access node in reply feedback signaling in a subframe spaced from the subframe N an amount of the reduced processing time. In a particular embodiment the computing means comprises at least one processor and at least one memory tangibly storing a computer program; and the radio communication means comprises a transmitter and a receiver.

### BRIEF DESCRIPTION OF THE DRAWINGS

FIG. 1 is a timing diagram showing a PDCCH sent in subframe N that schedules a PUSCH in subframe N+4 according to legacy timing/processing and also illustrates that PDCCH may instead schedule a PUSCH in subframe N+2 according to reduced/low-latency timing as set forth in the teachings herein.

FIG. 2 is similar to FIG. 1 but showing the legacy and reduced timing of ACK/NACK signaling that is associated with a PDSCH in subframe N.

FIG. 3 is a prior art illustration of legacy users-specific search spaces/PDCCH candidates for various aggregation levels (ALs) consistent with Table 9.1.1-1 of 3GPP TS 36.213 that requires N+4 latency.

FIG. 4 is similar to FIG. 3 but further illustrates by dashed shading one example for how the reduced search space can be defined to enable the reduced/low-latency timing set forth in the teachings herein.

FIGS. 5A-B are process flow diagrams summarizing certain aspects of the invention from the perspective of a network radio access node/eNodeB and of a user equipment/mobile device, respectively.

FIG. 6 is a diagram illustrating some components of a radio access node/eNodeB and a UE/mobile device, each of which are suitable for practicing various aspects of the invention.

### DETAILED DESCRIPTION

Example embodiments of these teachings provide a reduction in the size of the DL control channel search space (e.g., the maximum number of DL control channel blind decodes that will be needed) in order to enable shortened processing times at the UE side. In one respect the problem this invention addresses is how to define the DL control channel search space so as to enable dynamic switching between reduced and non-reduced processing times in a practical radio system. In one embodiment this reduced processing time mechanism exists side by side with legacy processing time operation and thereby enables to dynamically operate with reduced and non-reduced processing time. In the specific but non-limiting examples below the reduced processing times are enabled only for the user-specific search space, and the legacy processing times/latencies remain operative for the common search spaces at all times for all UEs. Moreover, the detailed examples below further describe a novel way of using the search space to distinguish UL and DL grants (DCIS in PDCCHs in LTE radio access technology) for different processing times; some may require the UE to operate with reduced processing time but others may not, and the embodiments below enable this flexibility with little (for some embodiments) or no (for other embodiments) added signaling overhead. The various embodiments and examples below are described in the context of a 3GPP/LTE type radio access technology but this is only an example radio environment and not a limit to the broader teachings herein.

In this regard, these teachings may be deployed so that the reduced processing time is the same for both uplink and downlink resource grants as described in the specific examples below. But in another embodiment these examples can be modified so there are two different reduced processing times, each shorter than the legacy 4 subframe/TTI processing time used in the LTE system, depending upon whether the granted resource is uplink or downlink. In such other embodiments the reduced processing time may be a first value if the allocated radio resource is uplink (i e UL grant to PUSCH transmission) and the reduced processing time may be a different second value if the allocated radio resource is downlink (i.e., PDSCH to HARQ-ACK feedback); where both the network and the UEs will know in advance from published specifications (or RRC configuration signaling to the UE) exactly what are the first and second values.

Embodiments of these teachings focus on the DL control search space definition for the operation of reduced processing time and the examples below consider legacy 1 ms TTI design in LTE, taking also the legacy operation including legacy processing times into account. Defining the UE's search space as detailed herein can enable, in certain embodiments, reduced processing time at the UE side, and can enable the UE to distinguish UL and DL grants for reduced processing time and legacy processing time.

To better clarify the advantages these teachings proffer, first is a review of the conventional processing time in LTE. The allowed processing time for LTE FDD (LTE FS1) have been defined in Rd. 8 to have an N+4 relationship between the PDSCH and the related HARQ-Ack feedback, as well as between an UL grant sent to the UE and the related PUSCH transmission by the UE. This means for the PDSCH transmitted with the DL resource allocation/grant that allocates it in subframe/TTI N, the UE is required to feedback the related HARQ-Ack feedback in subframe/TTI N+4. Similarly, a UL grant/resource allocation sent to the UE in subframe/TTI N requests the UE to send the related PUSCH in subframe/TTI N+4.

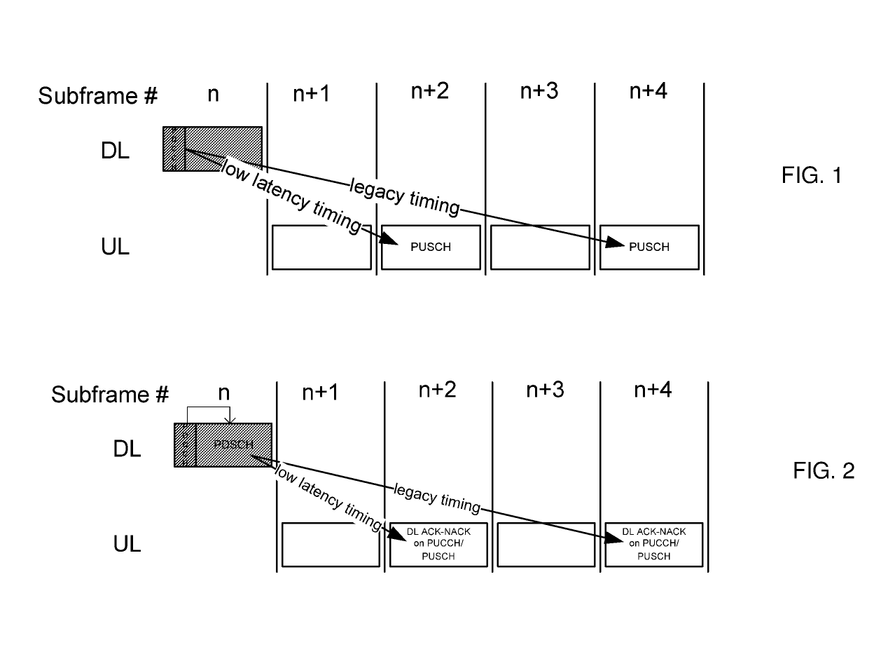

In conventional LTE the subframe/TTI length is 1 millisecond (ms). With reduced processing time for the 1 ms TTI length, these teachings enable a reduced processing time such that the UE can send the HARQ-Ack feedback earlier that subframe N+4, as well as transmit PUSCH earlier than N+4, where N is defined as the subframe in which the UL or DL grant is sent. Instead of the conventional LTE Rd. 8 timing relation of N+4, the minimum timing relation can be reduced to N+3 or even N+2 for example, as shown in FIGS. 1-2.

FIG. 1 shows a PDCCH sent from the network/eNodeB to the UE in subframe N. This PDCCH carries a DCI which allocates to the UE an uplink resource referred to as the PUSCH. With legacy processing latency the earliest this PUSCH can be allocated to the UE is subframe N+4 as FIG. 1 shows for legacy timing. This legacy processing delay is understood at both the network and UE sides and in fact is specified in publications that set forth mandatory operations/limitations for LTE. One of the reasons the UE must blind decode the PDCCH is to search for a valid UL grant; it does not know in advance exactly when the network might send a DCI addressing this particular UE, the UE has only a specified window in which it must search to find one if in fact the network sent this UE an UL grant on PDCCH with a PUSCH allocation. There may be other PDCCH candidates in this UE's search space that do not have a resource grant/allocation for this UE, but the UE must receive them and check to see which if any of these PDCCH candidates in its own search space address itself. Moreover, the UE will need to prepare the UL data for PUSCH transmission which includes data segmentation, data encoding, modulation, layer mapping and so on in order to create the finally SC-FDMA modulated PUSCH signaling for transmission. This is the purpose of imposing a minimum processing delay; to allow the UE to search all these PDCCH candidates and find one allocating to it a PUSCH in time to actually utilize that allocated PUSCH. In an example embodiment this processing delay between PDCCH and the PUSCH it allocates can be N+2, as FIG. 1 shows by example for the low-latency timing option.

FIG. 2 shows a similar legacy N+4 processing delay between downlink data that the UE receives on the PDSCH and the ACK/NACK the UE sends uplink on the PUCCH (or PUSCH). In the conventional LTE case the PDCCH allocates a PDSCH in the same subframe in which the PDCCH is sent, as FIG. 2 illustrates for subframe #n. The conventional HARQ process imposes a delay of 4 subframes from the subframe N in which the data is sent on the allocated PDSCH, which enables the UE to decode the downlink data on the PDSCH, re-tune its radio for transmitting, and prepare the HARQ-Ack information to be transmitted. With reduced processing time operation, the processing delay from downlink data to ACK/NACK can be 2 subframes (N+2) in an embodiment of these teachings as FIG. 2 shows by example for the low-latency timing option. Embodiments of the teachings enable the signaling of reduced and non-reduced processing time operation according to FIG. 2.

At least in part, the design of the LTE DL control search space necessitates this legacy N+4 processing delay. Specifically, per the LTE specification 3GPP TS 36.213 at section 9 the UE is required to monitor two different search spaces—the common search space (CSS) as well as the user-specific or UE-specific search space (USS). The following examples focus on PDCCH utilization, but the same principles would apply if USS on EPDCCH is enabled and configured for the UE.

Based on the LTE Rd. 8 design (see 3GPP TS 36.213 mentioned above), the UE is requested to monitor the following PDCCH candidates in its designated search space. Table 1 below is prior art, reproduced from Table 9.1.1-1 “PDCCH candidates monitored by a UE”.

TABLE 1
(reproduced from table 9.1.1-1) PDCCH candidates
monitored by a UE

| Search space Sₖ^{(L)} | | | Number of PDCCH |
|---|---|---|---|
| Type | Aggregation level L | Size [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

In the non-limiting embodiments described herein the restricted/reduced size search space is limited to only the USS and operation on the CSS remains unchanged. In these embodiments the CSS serves the purpose of keeping the operation in case of some different understanding of potential re-configuration issues as between the network and a UE, and so the unchanged CSS can always provide a fall-back scheduling mechanism. These described embodiments schedule PDSCH and PUSCH with reduced processing time only through the USS.

The DL control channel search space definition of LTE that is adjusted by these teachings has not changed much since its introduction in LTE Rd. 8. With the introduction of 256QAM for PDSCH (in Rel.12) and PUSCH (in Rd. 14) there was a differentiation introduced, that the UE interprets the DL and UL grants potentially different depending on whether they are transmitted on the common search space (CSS) or user-specific search space (USS). As an example, for PUSCH operation if an UL grant is transmitted to a UE on CSS this signifies 64QAM operation (i.e., the 64QAM modulation and coding scheme MCS table) whereas if the UL grant is transmitted to the UE on the USS this always assumes 256QAM operation (i.e. 264QAM PUSCH MCS table).

In Rd. 13 LTE extended the LTE carrier aggregation framework to 32 component carriers. Then the network was given the ability to reduce the number of (E)PDCCH USS candidates for a UE on a specific carrier by means of an RRC configuration; more specifically the RRC parameter pdcch-candidateReductions.

In related art, co-owned provisional U.S. patent Application Ser. No. 62/316,285 filed on Mar. 31, 2016 (also filed as international patent application PCT/FI2017/050050 on Jan. 30, 2017) describes three modes of operation for latency reduction, generally as shown in Table 2 below. In the “fast feedback mode” the feedback for a 1-ms DL TTI is provided faster, and further there is described an option of switching between the different modes based on whether CSS or USS were used to schedule the PDSCH transmission.

TABLE 2
Different modes of operation for latency reduction
according to co-owned patent application

| | DL TTI length | UL (PUCCH) TTI length | HARQ-ACK delay |
|---|---|---|---|
| Fall-back mode | 1 ms | 1 ms | HARQ-Ack is |
| | | | transmitted 4 TTIs |
| | | | (4 ms) later |
| Short TTI | Less than 1 ms (e.g. 1, | Less than 1 ms (e.g. 1, 2, 3, | HARQ-Ack is |
| mode | 2, 3, 4, or 7 OFDM- | 4, or 7 OFDM-symbols), | transmitted 4 sTTIs |
| | symbols) | preferably the same as the | (<=2 ms) later |
| | | DL TTI length | |
| Fast feedback | 1 ms | Less than 1 ms (e.g. 1, 2, 3, | HARQ-Ack is |
| mode | | 4, or 7 OFDM-symbols) | transmitted 4 sTTIs |
| | | | (<=2 ms) later |

These teachings expand upon those in that they enable a reduction in UE complexity associated with decoding DCI with reduced processing times. One mechanism to do so as will be further detailed below is to modify the DL control user-specific search space (USS) definitions.

According to example embodiments of these teachings the DL control channel USS candidates are split such that some of the USS candidates that define a reduced search space are associated with reduced processing times, whereas in various embodiments all or some of the USS candidates that define a larger or second search space are associated with N+4 legacy timing (more generally, non-reduced processing time). The reduced set of PDCCH USS candidates translates to a reduced search space in which the UE must perform blind decoding. This enables the UE to start DCI monitoring on the reduced set of PDCCH candidates on the USS, and it is only these reduced set of PDCCH candidates on the USS that can potentially carry the DL assignments and UL grants that employ the low-latency reduced processing timing. Reducing the set of PDCCH candidates the UE is to blindly detect reduces the time needed by the UE to find potential low-latency radio resource grants and assignments for it. In addition, the split of PDCCH candidates on the USS allows the dynamic switching (on a sub-frame/TTI basis) between legacy and low-latency operation. That is, the CSS operation remains unchanged and the USS operation enables low latency operation in parallel with legacy latency operation in a given cell, and even on a given carrier within that cell.

For the PUSCH radio resources that are allocated to the UE via the PDCCH UL grant, if there is reduced latency in operation for that particular PDCCH UL grant the PDCCH in subframe N allocates a PUSCH in subframe <N+4 which enables to reduce the PUSCH HARQ-Ack round-trip time (RTT) to be <N+8. Similarly, for the PDSCH radio resources that are allocated to the UE via the PDCCH DL assignment, if there is reduced latency in operation for that particular PDCCH then the HARQ feedback signaling associated with the PDSCH that it allocates will also be handled according to the reduced latency timings (e.g., the DL grant and PDSCH in subframe N is associated with ACK/NACK signaling in subframe <N+4). This enables to reduce the DL HARQ-Ack RTT to be <N+8.

Embodiments of these teachings yield a reduction in the number of blind decodes that will be needed for UL/DL grants that impose reduced processing time scheduling, while still maintaining conventional operation with the legacy processing time. As mentioned above, embodiments of these teachings enable this by limiting the size of a given UE's search space in which it must blind decode PDCCHs to see if one of them allocates resources to that given UE.

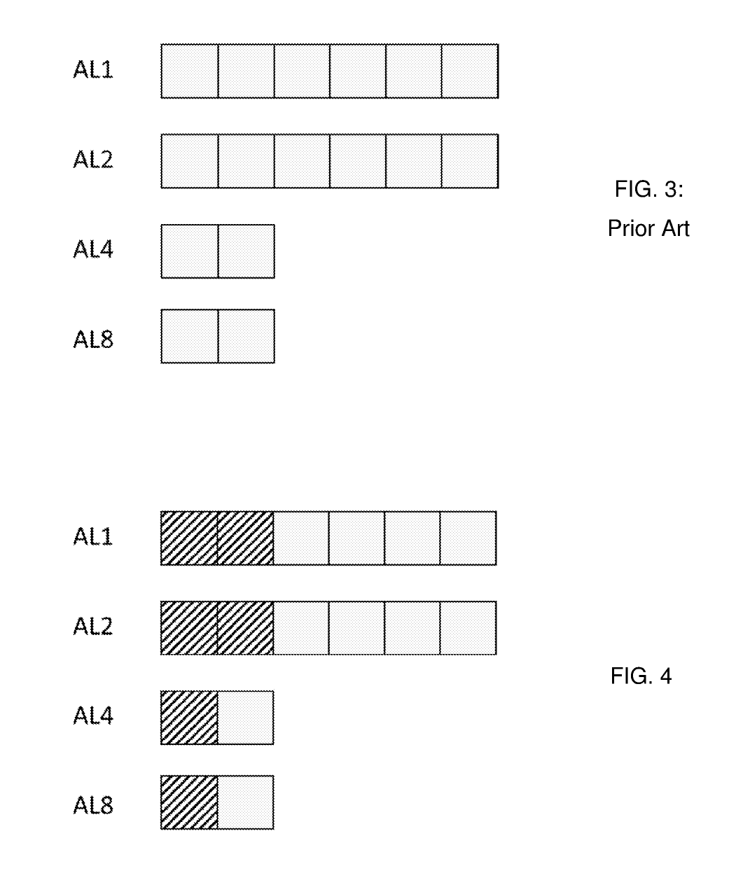

A graphical representation of such a reduced search space is shown with reference to FIGS. 3-4. In general, FIG. 3 can be considered as the legacy/larger user-specific search space that requires N+4 latency, and it illustrates the PDCCH candidates for various aggregation levels (ALs), consistent with table 1 above (reproduced from Table 9.1.1-1 of 3GPP TS 36.213).

FIG. 4 illustrates by dashed shading one implementation of the search space reduction from the legacy search space of FIG. 3. Specifically: for each of aggregation level 1 (AL1) and AL2 the UE's search space is reduced from 6 PDCCH candidates to 2 PDCCH candidates; and for each of AL4 and AL8 the UE's search space is reduced from 2 PDCCH candidates to 1 PDCCH candidate.

The illustration in FIG. 4 assumes the chronologically first x candidates of the legacy/larger USS search space are used with reduced processing time. The value of the positive integer x may in one implementation be predetermined for each aggregation level. Alternatively, only the maximum value for x is predefined in published specifications and the eNodeB may configure the operational value for x in the cell, for example via RRC signaling.

In other embodiments, rather than only the x PDCCH candidates that are first-in-time within the UE's largest (legacy) search space, the x PDCCH candidates that define the reduced size search space may be those with the largest indices, or these x PDCCH candidates can be interleaved so that they are each non-adjacent to one another for a given aggregation level.

The following example focuses on the downlink control information (DCI) containing a DL assignment for PDSCH scheduling on USS, but this example is applicable also for UL grants as well where the DCI allocates a PUSCH to the UE.

Referring again to FIG. 4, consider for the following description of three example implementations that the scheduling with reduced processing time (of N+2 or N+3) can occur only on the striped candidates and the legacy PDSCH scheduling (with legacy processing time of N+4) can occur on either the striped or the solid-shaded candidates. There are several ways to implement this reduced search space in a practical wireless radio network.

In a first implementation different sized DCI formats are used to schedule reduced processing time PDSCH and legacy processing time PDSCH. In this regard the signaling to the UE to use reduced processing time is implicit in the DCI format itself (so long as that DCI format is in the USS reduced search space). For this first implementation the UE would look for the DCI format scheduling reduced processing time PDSCH on the striped candidates only. In a preferred embodiment of this first implementation, the UE would firstly start with monitoring the striped candidates for the DCI format scheduling reduced processing time to enable the reduction of the maximum processing time needed to decode the DL grant for reduced processing time PDSCH.

Preferably the legacy processing time option exists side by side with the reduced processing time, and so for this first implementation there are also several alternatives for monitoring the legacy DCI format scheduling PDSCH. In one such embodiment the UE is specifically requested to monitor the legacy DCI scheduling with N+4 legacy timing on all the PDCCH candidates (for example, all the striped and solid shaded candidates in FIG. 4 for this UE's AL) based on the legacy operation. So for example if the UE receives in the reduced search space a DCI format, the format of the DCI in this implementation tells whether reduced or legacy processing time is to be employed for this particular resource allocation. In another such embodiment the UE is requested to monitor the legacy DCI scheduling PDSCH with legacy processing time requirements only on the candidates that are not applicable for the reduced processing time operation (for example, only the solid-shaded candidates of FIG. 4 for this UE's AL, so 4 candidates each for AL1 and AL2 but only 1 candidate each for AL4 and AL8). A further embodiment combines certain features of these two; the UE is requested to monitor the legacy DCI scheduling PDSCH with legacy processing time requirements on the candidates that are not applicable for reduced processing time operation (the solid-shaded candidates in FIG. 4) and on a subset of the candidates used for reduced processing time operation (on a subset of the striped candidates in FIG. 4). This ‘hybrid’ option allows the trade-off between size of legacy USS and additional complexity from an increased total number of DL control blind decodes.

Whichever of the 3 options above is used for this first implementation, preferably the UE behavior would be to monitor for DCI format scheduling PDSCH with legacy processing time requirements on the respective PDCCH search space candidates only after having finished monitoring for DCI format scheduling reduced processing time PDSCH on the reduced USS (striped candidates). In an alternative example the UE will search for the DCI format scheduling PDSCH with legacy processing time requirements on the respective PDCCH search space candidates only if there was no reduced processing time DCI addressing this UE successfully decoded in the reduced search space (striped candidates). Specifically for PDSCH operation and not applicable for UL grants/PUSCH operation: for the case that simultaneous transmission of legacy and low-latency PDSCH is not supported the UE may skip the second step of searching for DL assignment with legacy/non-reduced timing if it found a valid DL assignment for reduced processing time in the first step; but for the case that simultaneous transmission of legacy and low-latency PDSCH is supported the UE cannot and should not stop monitoring for DL grants after first step since there may be one legacy and one low-latency PUSCH scheduled in the same DL subframe for this UE. And if the UE is not configured by the network for reduced processing time operations (or not configured on the particular carrier on which it receives this DCI/PDCCH) it will only monitor for the DCI with legacy/non-reduced timing on the legacy/larger search space.

In a second implementation the format (size, etc.) of the DCI does not indicate reduced or legacy processing time; the same DCI format may be used to schedule reduced processing time PDSCH as well as legacy processing time PDSCH. In this second implementation it is the content within the DCI itself that defines whether reduced processing time or legacy processing time is to be used for the scheduled PDSCH. In this regard the signaling to the UE to use reduced processing time is explicit in the DCI content; the DCI contains some indication whether legacy processing time or reduced processing time is to be applied.

In a preferred embodiment of this second implementation, the UE would first only monitor for the DCI format of the DL grants on the PDCCH candidates for reduced processing time (the striped candidates in FIG. 4) to be able to reduce the DL control decoding processing time for reduced processing time PDSCH operation. These striped candidates might contain DL grants indicating reduced processing time PDSCH operation or indicating normal, legacy processing time PDSCH operation.

In a next/second step, the UE would monitor for DL grant of the remaining PDCCH candidates and these candidates can schedule only with legacy processing time. In FIG. 4 these remaining candidates are the solid-shaded PDCCH candidates. Specifically, for PDSCH operation and assuming that simultaneous transmission of legacy and low-latency PDSCH is not supported, the UE may skip the second step immediately above when it finds a DL assignment for it in the first step. This particularity is not applicable for UL grants/PUSCH operation. If instead the practical implementation does support simultaneous transmission of legacy and low-latency PDSCH the UE cannot and should not stop monitoring for DL grants after the above first step since in that case there might be one legacy and one low-latency PUSCH scheduled for the UE in the same DL subframe, if simultaneous transmission of legacy and low-latency PDSCH is supported. In any case, if the UE decodes a DL grant on one of the legacy-only PDCCH candidates (the solid shaded candidates of FIG. 4) that indicates reduced processing time, the UE is to regard this as an error case and the UE will consequently not try to decode the scheduled PDSCH and will not provide any HARQ feedback for it.

In a third implementation, the specific DCI format (size and content) is not relevant to whether reduced or legacy processing time is to be used, and in this regard is similar to the second implementation. Thus the same DCI format can be used for scheduling either processing time option. This third implementation differentiates between legacy processing time and shortened/reduced processing time for the UE implicitly according to the USS PDCCH candidate. So unlike the second implementation above it is not the content of the DCI that gives the UE this indication but instead it is the PDCCH candidate in which the UE receives the DCI that tells whether reduced or legacy processing time is to be used for the scheduled PDSCH. In the FIG. 4 example, if the UE received a DCI of any format scheduling a PDSCH/PUSCH in one of the striped candidates the UE is to handle it as reduced processing time whereas if the UE received a DCI of any format scheduling a PDSCH/PUSCH in one of the solid-shaded candidates the UE is to handle it as legacy processing time.

In a preferred embodiment of this third implementation, the UE would firstly start with monitoring the striped candidates, thus enabling the reduction of the maximum processing time needed to decode the DCI format scheduling any reduced processing time PDSCHs. In case a DL grant is decoded on one of the striped candidates, this makes the UE implicitly aware that reduced processing time is to be applied for mapping the allocated PDSCH and further to provide HARQ-Ack feedback with reduced processing time.

Following that, in a next/second step the UE would monitor for DL grant of the remaining PDCCH candidates that can schedule only with legacy processing time, which are those candidates depicted in FIG. 4 by solid shading. If the UE decodes a DL grant on one of the remaining PDCCH candidates after the first step (that is, in one of the solid-shaded candidates of FIG. 4) this makes the UE implicitly aware that legacy processing time is applied and that HARQ-Ack feedback with the legacy (N+4) timing is to be provided by the UE. Specifically for PDSCH operation and not applicable for UL grants/PUSCH operation: for the case that simultaneous transmission of legacy and low-latency PDSCH is not supported the UE may skip the second step when a DL assignment is found in the first step; but for the case that simultaneous transmission of legacy and low-latency PDSCH is supported the UE cannot and should not stop monitoring for DL grants after first step since there may be one legacy and one low-latency PUSCH scheduled in the same DL subframe for this UE.

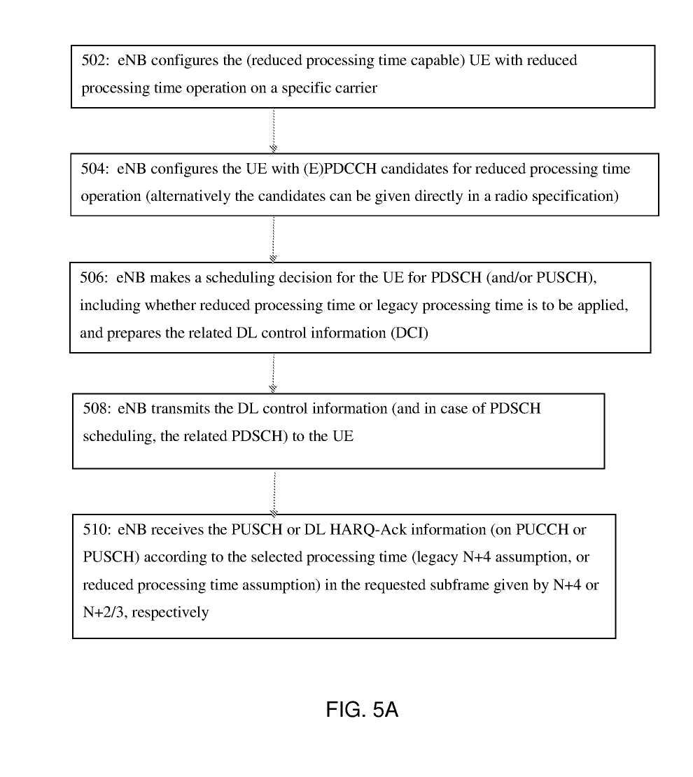

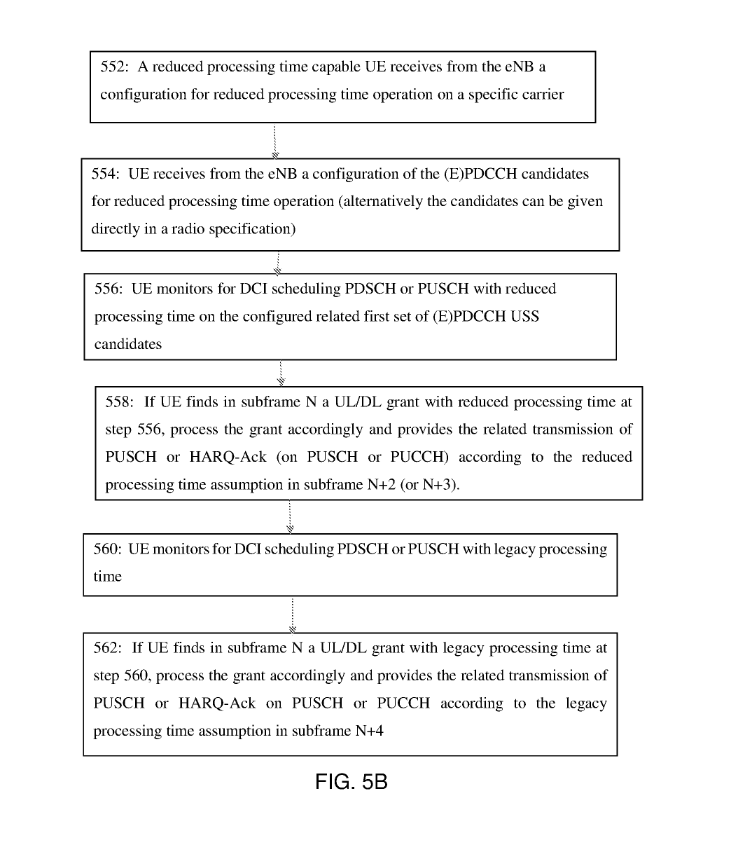

FIG. 5A is a process flow diagram showing detailed actions performed by an eNodeB or other such radio network base station/radio access node according to certain embodiments of these teachings. At block 502 the eNodeB configures the (reduced processing time capable) UE with reduced processing time operation on a specific carrier. In this regard a given UE can be configured for reduced processing time on one or more carriers and for only legacy processing time on one or more other carriers in a carrier aggregation radio network such as LTE. At block 504 the eNodeB configures the UE with (E)PDCCH candidates for reduced processing time operation. Alternatively, the number of candidates could be given in specification directly and thus not configurable by the radio network, but in either case at this juncture both eNodeB and UE understand what is defined as the reduced search space to use for reduced processing time resource allocations. As examples, such specification(s) can be for LTE Rd. 14 or for MulteFire L1. In either case the reduced processing time operations are associated with the reduced search space, so for example signaling via a DCI which allocates resources that reduced processing time operations are to be utilized for those resources implies that the reduced search space is to be used also.

The remainder of FIG. 5A assumes the actions are for the specific carrier of block 502. With the configuration set now at block 506 the eNodeB makes a specific scheduling decision for the UE, for PDSCH and/or PUSCH which is/are the radio resource(s) allocated to the UE by the eNodeB via the PDCCH/DCI still to be sent. The examples above are for PDSCH but as mentioned the skilled person will readily recognize that the PUSCH operation is substantially similar. This scheduling decision includes selecting whether reduced processing time or legacy processing time is to be applied. With these matters decided the eNodeB then prepares the related DL control information (DCI).

The eNodeB transmits at block 508 the DL control information. In the case of PDSCH scheduling, the eNodeB also transmits the related PDSCH to the UE in this step. In case reduced processing time is requested for the UE per block 506, the eNodeB places the DCI format of block 508 that schedules PDSCH and/or PUSCH on one of the respective reduced number of (E)PDCCH candidates for reduced processing time operation. In the FIG. 4 example this would be one of the striped candidates. In case legacy processing time is requested for the UE at block 506, the eNodeB places the DCI format of block 508 that schedules PDSCH or PUSCH on one of the remaining (E)PDCCH candidates for legacy processing time. In the FIG. 4 example this would be one of the solid-shaded candidates. In certain embodiments such as the ‘hybrid’ option discussed under the first implementation above, the eNodeB may in addition place the DCI scheduling PDSCH or PUSCH with legacy processing time also on one of the striped candidates of FIG. 4, where this particular striped candidate is available for both reduced processing time scheduling and legacy processing time scheduling. But in this embodiment there is at least one candidate that is reserved for only reduced processing time scheduling, assuming proper configuration of the UE per blocks 502 and 504. In other embodiments detailed above the reduced versus non-reduced processing time may be indicated implicitly in the format of the DCI/PDCCH, or in the content of the DCI/PDCCH.

With the PDSCH radio resource now allocated to the UE (in the same subframe N as the DCI/PDCCH that allocated it), the eNodeB at block 510 receives the DL HARQ-Ack information (on PUCCH) according to the selected processing time (legacy N+4 assumption, or reduced processing time assumption) in the requested subframe given by N+4 or N+2/3, respectively. If instead it was a PUSCH radio resource that was allocated to the UE via a DCI/PDCCH in subframe N the eNodeB would instead receive at block 510 the allocated PUSCH with the UE's UL data corresponding legacy or reduced processing time from that allocated PUSCH resource in the subframe given by N+4 or N+2/3, respectively.

The process flow set forth at FIG. 5A for a radio access node can be re-stated more generally as follows. The radio access node sends to a user equipment (UE) an indication that reduced processing time which is associated with a search space that is operational for the UE, wherein the reduced search space is a sub-set of a larger search space associated with a non-reduced processing time; and the radio access node sends to the UE within the reduced search space downlink control information (DCI) in subframe N that allocates to the UE a radio resource. Thereafter, if the allocated radio resource is uplink the radio access node receives (uplink) data from the UE on the allocated radio resource in a subframe spaced from the subframe N an amount of the reduced processing time; and/or if the allocated radio resource is downlink the radio access node sends (downlink) data to the UE on the allocated radio resource in subframe N and receiving from the UE in reply feedback signaling (about the downlink data) in a subframe spaced from the subframe N an amount of the reduced processing time.

Above was described three different implementations. According to the first implementation a format of the DCI that allocates the radio resource where that DCI is also sent within the reduced search space is implicitly the indication that the reduced processing time is operational for the scheduled PDSCH/PUSCH resource of the UE. According to the second implementation content of the DCI that allocates the radio resource where that DCI is also sent within the reduced search space is explicitly the indication that the reduced processing time is operational for the scheduled PDSCH/PUSCH of the UE. And according to the third implementation the placement of the sent DCI (that allocates the radio resource) within the search space that is the sub-set of the legacy search space is implicitly the indication that the reduced processing time is operational for the scheduled PDSCH/PUSCH of the UE.

For any of the above re-stated steps the DCI that allocates the radio resources is the indication that the reduced processing time is to be applied and the indication is valid only on a carrier on which that DCI is sent and for which the radio access node has previously configured the UE for reduced processing time operation. In one embodiment the reduced search space is configured for the UE and thereby associated with the reduced processing time via signaling from the radio access node, whereas in an alternative embodiment such reduced search space configuration is not needed or even allowed since the reduced search space is pre-defined by at least one published radio specification that associates it with the reduced processing time operations.

In a further embodiment where the reduced and non-reduced processing exist side by side, without changing a processing time configuration of the UE the radio access node sends to the UE a further DCI in a subframe N′ that allocates to the UE a further radio resource, where the further DCI that allocates the further radio resource does not indicate that reduced processing time is operational; and thereafter if the further allocated radio resource is uplink the radio access node receives data from the UE on the allocated resource in a subframe spaced from the subframe N′ an amount of the non-reduced processing time; and/or if the further allocated radio resource is downlink the radio access node sends data to the UE on the allocated radio resource in subframe N′ and it receives from the UE in reply feedback signaling in a subframe spaced from the subframe N′ an amount of the non-reduced processing time.

In the specific non-limiting examples above the processing time is defined in terms of subframes and/or transmission time intervals, the non-reduced processing time is equivalent to a length of four subframes and/or transmission time intervals and the reduced processing time is equivalent to a length of less than four subframes and/or transmission time intervals. While not specifically detailed in a particular example above, in another embodiment the reduced processing time can be a first value if the allocated radio resource is uplink and the reduced processing time can be a different second value if the allocated radio resource is downlink.

The above re-stated steps can be embodied as steps of a method performed by the radio access node; or as a computer readable memory tangibly storing a computer program that when executed causes a radio access node to perform such steps; or as an apparatus comprising at least one processor and at least one memory tangibly storing a computer program wherein the at least one processor is configured with the at least one memory and the computer program to cause the apparatus to perform such steps (where the apparatus may be the radio access node or components thereof). In another embodiment there is an apparatus comprising radio communication means and computing means for performing the re-stated steps above, where the computing means are for deciding which DCI that allocates radio resource is to be handled using the reduced processing time and the radio communication means is for sending and receiving as above. In a particular embodiment the computing means is embodied as at least one processor and at least one memory tangibly storing a computer program, and the radio communication means includes a transmitter and a receiver.

FIG. 5B is a process flow diagram showing detailed actions performed by a UE according to certain embodiments of these teachings. At block 552 a reduced processing time capable UE receives from the eNodeB a configuration for reduced processing time operation on a specific carrier. Then at block 554 this UE receives from the eNodeB a configuration of the (E)PDCCH candidates for reduced processing time operation, or alternatively the number of candidates could be given in specification directly and not be configurable.

At block 556 the UE monitors for DCI scheduling PDSCH or PUSCH with reduced processing time on the configured related first set of (E)PDCCH USS candidates. Per the three implementations above: for the first implementation the UE will look for the respective DCI format for reduced processing time; else for the second implementation the UE will know depending on the content of the correctly decoded UL/DL grant if reduced processing time or legacy processing is to be applied; else for the third implementation a successfully decoded UL/DL grant on these candidates in the reduced search space will directly implicitly instruct the UE to handle the scheduled PUSCH/PDSCH with reduced processing timing assumptions.

In case the UE finds a UL/DL grant with reduced processing time at step 556 in subframe N, then at step 558 the UE processes the grant accordingly and provides the related transmission of PUSCH or HARQ-Ack on PUSCH or PUCCH according to the reduced processing time assumption in subframe N+2 (or N+3).

In some deployments of these of these teachings it may be that the UE that finds a reduced processing time grant need not search for other legacy processing time grants until the next search space. Blocks 560 and 562 assume the UE either is to so monitor, or it found no reduced processing time grant at block 556. At block 560 the UE monitors for DCI scheduling PDSCH or PUSCH with legacy processing time and there are various implementations and embodiments for this step detailed above with more particularity. For the first implementation there are three examples described above: in one example the UE will look for the respective DCI format for legacy processing time on all the legacy PDCCH candidates (these would be both striped and solid-shaded candidates in FIG. 4); in another example the UE will look for the respective DCI format for legacy processing time on the remaining additional PDCCH candidates (these would be only the solid-shaded candidates in FIG. 4); and in a third example the UE will look for the respective DCI format for legacy processing time on the remaining additional PDCCH candidates (the solid-shaded candidates in FIG. 4) and also on a subset of the PDCCH candidates used for reduced processing time (which would be a subset of the striped candidates in FIG. 4).

Applying the second implementation described above to block 560 would have the UE monitoring DCIs on the additional PDCCH candidates (the solid-shaded candidates in FIG. 4) for UL/DL grants with legacy processing times. As noted above, if the UE finds a UL/DL grant on these PDCCH candidates that indicate reduced processing time, the UE is to treat this grant as an error and neglect it). Applying the third implementation described above to block 560, a successfully decoded UL/DL grant on the remaining PDCCH candidates (the solid-shaded candidates in FIG. 4) will directly implicitly instruct the UE to handle the scheduled PUSCH/PDSCH with legacy processing timing assumptions.

And finally, if the UE does find at block 560 a UL/DL grant with legacy processing time in subframe N that is not treated as an error as noted immediately above, the UE at block 562 processes the grant accordingly and provides the related transmission of PUSCH or HARQ-Ack on PUSCH or PUCCH according to the legacy processing time assumption in subframe N+4.

Preferably, the UE performing according to FIG. 5B will first do steps 556 and 558, and if warranted only then perform steps 560 and 562. This is because there would be less time available for the UE to perform the reduced processing time operations at steps 556 and 558 as compared to the longer legacy processing times available for performing steps 560 and 562.

The process flow set forth at FIG. 5B for a UE can be re-stated more generally as follows. The UE receives from a radio access node an indication that reduced processing time which is associated with a reduced search space is operational for the UE. As with the network-side description above, for the UE also this reduced search space is a sub-set of a larger search space associated with a non-reduced processing time. The UE receives from the radio access node downlink control information (DCI) in a subframe N that allocates a radio resource; and thereafter if the allocated radio resource is uplink the UE sends UL data to the radio access node in a subframe spaced from the subframe N an amount of the reduced processing time, and/or if the allocated radio resource is downlink the UE receives (downlink) data from the radio access node on the allocated radio resource in subframe N and sends to the radio access node in reply feedback signaling (about the downlink data) in a subframe spaced from the subframe N an amount of the reduced processing time

In one specific embodiment the DCI scheduling PDSCH/PUSCH is the indication that the reduced processing time is to be applied and the indication is valid only on a carrier on which the DCI is received and for which a user equipment (UE) performing these re-stated steps has been previously configured by the radio access node for reduced processing time operation. That is, if the UE is configured on carrier #1 for reduced processing time operation but not similarly configured on carrier #2, the UE will handle a DCI on carrier #2 according to legacy processing times regardless of its format, content, or placement among the search space candidates.

In one embodiment the reduced search space is configured for the user equipment (UE) performing these re-stated steps via signaling this UE receives from the radio access node. In an alternative embodiment such configuration is not necessary because the reduced search space is pre-defined by at least one published radio specification.

In a further embodiment where the reduced and non-reduced processing exist side by side, without changing a processing time configuration of the UE the UE also receives from the radio access node a further DCI in a subframe N′ that allocates to the UE a further radio resource, where the further DCI does not indicate that reduced processing time is operational for the UE; and thereafter if the further allocated radio resource is uplink the UE sends data to the radio access node in a subframe spaced from the subframe N′ an amount of the non-reduced processing time; and/or if the further allocated radio resource is downlink the UE receives data from the radio access node on the further allocated radio resource in subframe N′ and sends to the radio access node in reply feedback signaling in a subframe spaced from the subframe N′ an amount of the non-reduced processing time.

The above re-stated steps can be embodied as steps of a method performed by the UE; or as a computer readable memory tangibly storing a computer program that when executed causes a UE to perform such steps; or as an apparatus comprising at least one processor and at least one memory tangibly storing a computer program wherein the at least one processor is configured with the at least one memory and the computer program to cause the apparatus to perform such steps (where the apparatus may be the UE or components thereof). In another embodiment there is an apparatus comprising radio communication means and computing means for performing the re-stated steps above, where the computing means are for determining which from among multiple received DCIs that allocate radio resources is/are to be handled using the reduced processing time and the radio communication means is for receiving and sending as above. In a particular embodiment the computing means is embodied as at least one processor and at least one memory tangibly storing a computer program, and the radio communication means includes a receiver and a transmitter.

Each of FIGS. 5A-B themselves, as well as the re-stated steps following the above description of those figures, can be considered as an algorithm, and more generally represents steps of a method, and/or certain code segments of software stored on a computer readable memory or memory device that embody the respective FIG. 5A-B or re-stated algorithm for implementing these teachings from the perspective of that respective device (eNodeB/base station or similar radio network access node, or UE). In this regard the invention may be embodied as a non-transitory program storage device readable by a machine such as for example one or more processors of a radio network access node or UE, where the storage device tangibly embodies a program of instructions executable by the machine for performing operations such as those shown at FIGS. 5A-B or as re-stated as particularly detailed above.

Certain embodiments of these teachings provide at least the technical effect of enabling a compact search space definition that provides for the joint operation of reduced processing time and legacy processing time data channel operations. A further technical effect is that these teachings enable the definition of a shared search space for both operation modes. And at least for the third implementation detailed above the UE would directly know the applicable processing time and therefore, the legacy DCI formats can be used directly to schedule data channels with different processing times. In the examples above a further technical effect is the switching between reduced and non-reduced processing time is dynamic since the indication that reduced processing time is operational is within a given DCI that allocates resources and that indication is valid only for the resources allocated by that DCI.

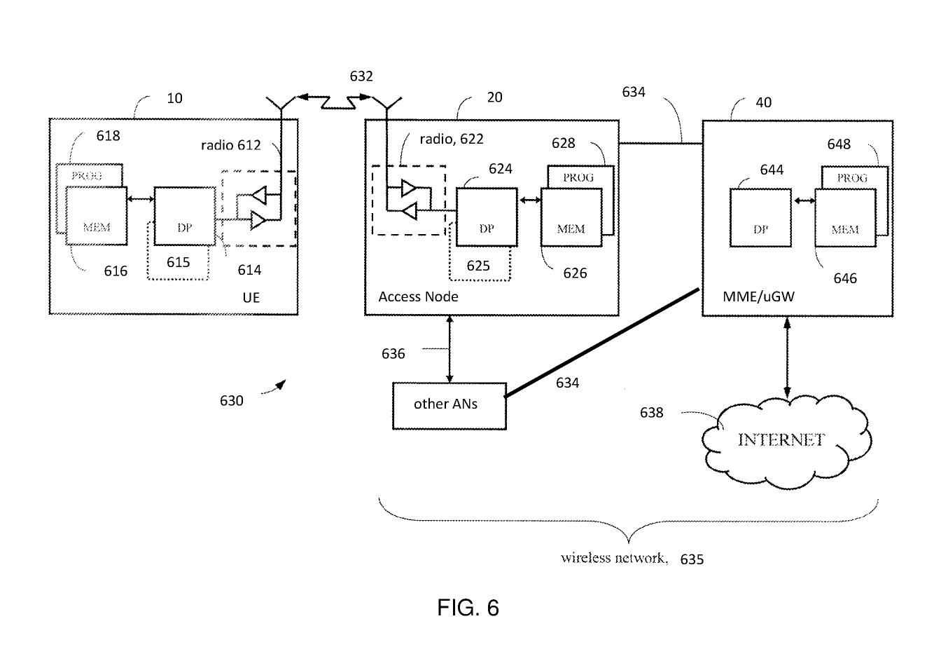

FIG. 6 is a high level diagram illustrating some relevant components of various communication entities that may implement various portions of these teachings, including a base station identified generally as a radio network access node 20, a mobility management entity (MME) which may also be co-located with a user-plane gateway (uGW) 40, and a user equipment (UE) 10. In the wireless system 630 of FIG. 6 a communications network 635 is adapted for communication over a wireless link 632 with an apparatus, such as a mobile communication device which may be referred to more concisely as a UE 10, via a wireless network radio access node 20. The network 635 may include a MME/Serving-GW 40 that provides connectivity with other and/or broader networks such as a publicly switched telephone network and/or a data communications network (e.g., the internet 638).

The UE 10 includes a controller, such as a computer or a data processor (DP) 614 (or multiple ones of them), a computer-readable memory medium embodied as a memory (MEM) 616 (or more generally a non-transitory program storage device) that stores a program of computer instructions (PROG) 618, and a suitable wireless interface, such as radio frequency (RF) transceiver or more generically a radio 612, for bidirectional wireless communications with the radio network access node 20 via one or more antennas. In general terms the UE 10 can be considered a machine that reads the MEM/non-transitory program storage device and that executes the computer program code or executable program of instructions stored thereon. While each entity of FIG. 6 is shown as having one MEM, in practice each may have multiple discrete memory devices and the relevant algorithm(s) and executable instructions/program code may be stored on one or across several such memories.

In general, the various embodiments of the UE 10 can include, but are not limited to, mobile user equipments or devices, cellular telephones, smartphones, wireless terminals, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The radio access node 20 also includes a controller, such as a computer or a data processor (DP) 624 (or multiple ones of them), a computer-readable memory medium embodied as a memory (MEM) 626 that stores a program of computer instructions (PROG) 628, and a suitable wireless interface, such as a RF transceiver or radio 622, for communication with the UE 10 via one or more antennas. The radio access node 20 is coupled via a data/control path 634 to the MME 40. The path 634 may be implemented as an S1 interface. The radio network access node 20 may also be coupled to other radio access nodes via data/control path 636, which may be implemented as an X5 interface.

The MME 640 includes a controller, such as a computer or a data processor (DP) 644 (or multiple ones of them), a computer-readable memory medium embodied as a memory (MEM) 646 that stores a program of computer instructions (PROG) 648.

At least one of the PROGs 618, 628 is assumed to include program instructions that, when executed by the associated one or more DPs, enable the device to operate in accordance with exemplary embodiments of this invention. That is, various exemplary embodiments of this invention may be implemented at least in part by computer software executable by the DP 614 of the UE 10; and/or by the DP 624 of the radio access node 20; and/or by hardware, or by a combination of software and hardware (and firmware).

For the purposes of describing various exemplary embodiments in accordance with this invention the UE 10 and the radio access node 20 may also include dedicated processors 615 and 625 respectively.

The computer readable MEMs 616, 626 and 646 may be of any memory device type suitable to the local technical environment and may be implemented using any suitable data storage technology, such as semiconductor based memory devices, flash memory, magnetic memory devices and systems, optical memory devices and systems, fixed memory and removable memory. The DPs 614, 624 and 644 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 612 and 622) may be of any type suitable to the local technical environment and may be implemented using any suitable communication technology such as individual transmitters, receivers, transceivers or a combination of such components.

A computer readable medium may be a computer readable signal medium or a non-transitory computer readable storage medium/memory. A non-transitory computer readable storage medium/memory does not include propagating signals and may be, for example, but not limited to, an electronic, magnetic, optical, electromagnetic, infrared, or semiconductor system, apparatus, or device, or any suitable combination of the foregoing. Computer readable memory is non-transitory because propagating mediums such as carrier waves are memoryless. More specific examples (a non-exhaustive list) of the computer readable storage medium/memory would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

A communications system and/or a network node/base station may comprise a network node or other network elements implemented as a server, host or node operationally coupled to a remote radio head. At least some core functions may be carried out as software run in a server (which could be in the cloud) and implemented with network node functionalities in a similar fashion as much as possible (taking latency restrictions into consideration). This is called network virtualization. “Distribution of work” may be based on a division of operations to those which can be run in the cloud, and those which have to be run in the proximity for the sake of latency requirements. In macro cell/small cell networks, the “distribution of work” may also differ between a macro cell node and small cell nodes. Network virtualization may comprise the process of combining hardware and software network resources and network functionality into a single, software-based administrative entity, a virtual network. Network virtualization may involve platform virtualization, often combined with resource virtualization. Network virtualization may be categorized as either external, combining many networks, or parts of networks, into a virtual unit, or internal, providing network-like functionality to the software containers on a single system.

Below are some acronyms used herein:

3GPP Third Generation Partnership Project

ACK Acknowledgement

AL Aggregation Level

CSS Common Search Space

DCI Downlink Control Information

DL Downlink

eNodeB Enhanced NodeB (base station in a LTE system)

EPDCCH Enhanced Physical Downlink Control Channel

HARQ Hybrid Automatic Retransmission request

LTE Long Term Evolution

MCS Modulation and Coding Scheme

NACK Negative Acknowledgement

OFDM Orthogonal Frequency Division Multiplexing

PDCCH Physical Downlink Control Channel

PDSCH Physical Downlink Shared Channel

PUCCH Physical Uplink Control Channel

PUSCH Physical Uplink Shared Channel

QAM Quadrature Amplitude Modulation

RAN Radio Access Network

Rel Release

RRC Radio Resource Control

RTT Round Trip Time

SI Study Item

TSG Technical Specification Group

TTI Transmission Time Interval

UCI Uplink Control Information

UE User Equipment

UL Uplink

USS User-specific (or UE-specific) Search Space

WG Working Group

WI Work Item

1-46. (canceled)

47. An apparatus comprising: at least one processor; and at least one memory tangibly storing a computer program,
wherein the at least one processor is configured with the at least one memory and the computer program to cause the apparatus to
receive from a radio access node an indication that reduced processing time that is associated with a reduced search space is operational for a user equipment (UE), wherein the reduced search space is a sub-set of a larger search space associated with a non-reduced processing time;
receive from the radio access node downlink control information (DCI) in a subframe N that allocates a radio resource; and thereafter
if the allocated radio resource is uplink, send uplink data to the radio access node in a subframe spaced from the subframe N an amount of the reduced processing time, and/or
if the allocated radio resource is downlink, receive downlink data from the radio access node on the allocated radio resource in subframe N and send to the radio access node in reply feedback signaling in a subframe spaced from the subframe N an amount of the reduced processing time.

48. The apparatus according to claim 47, wherein a format of the DCI allocating the radio resource that is received within the reduced search space is implicitly the indication that the reduced processing time is operational for the UE and the allocated radio resource.

49. The apparatus according to claim 48, wherein content of the DCI allocating the radio resource that is received within the reduced search space is explicitly the indication that the reduced processing time is operational for the UE and the allocated radio resource.

50. The apparatus according to claim 47, wherein placement of the DCI allocating the radio resource that is received within the reduced search space is implicitly the indication that the reduced processing time is operational for the UE and the allocated radio resource.

51. The apparatus according to claim 47, wherein the apparatus is the UE, the DCI allocating the radio resource is the indication that the reduced processing time is to be applied and the indication is valid only on a carrier on which the DCI allocating the radio resource is received and for which the radio access node has previously configured the UE for reduced processing time operation.

52. The apparatus according to claim 47, wherein the at least one processor configured with the at least one memory and the computer program to cause the apparatus to without changing a processing time configuration of the UE,
receive from the radio access node a further DCI in a subframe N′ that allocates to the UE a further radio resource, where the further DCI allocating the further radio resource does not indicate that reduced processing time is operational; and thereafter
if the further allocated radio resource is uplink, send uplink data to the radio access node in a subframe spaced from the subframe N′ an amount of the non-reduced processing time; and/or
if the further allocated radio resource is downlink, receive downlink data from the radio access node on the further allocated radio resource in subframe N′ and send to the radio access node in reply feedback signaling in a subframe spaced from the subframe N′ an amount of the non-reduced processing time.

53. The apparatus according to claim 47, wherein the processing time is defined in terms of subframes and/or transmission time intervals, the non-reduced processing time is equivalent to a length of four subframes and/or transmission time intervals and the reduced processing time is equivalent to a length of less than four subframes and/or transmission time intervals.

54. The apparatus according to claim 47, wherein the reduced processing time is a first value if the allocated radio resource is uplink and the reduced processing time is a different second value if the allocated radio resource is downlink.

55. A method comprising:
receiving from a radio access node an indication that reduced processing time that is associated with a reduced search space is operational for a user equipment (UE), wherein the reduced search space is a sub-set of a larger search space associated with a non-reduced processing time;
receiving from the radio access node downlink control information (DCI) in a subframe N that allocates a radio resource; and thereafter
if the allocated radio resource is uplink, sending uplink data to the radio access node in a subframe spaced from the subframe N an amount of the reduced processing time, and/or
if the allocated radio resource is downlink, receiving downlink data from the radio access node on the allocated radio resource in subframe N and sending to the radio access node in reply feedback signaling in a subframe spaced from the subframe N an amount of the reduced processing time.

56. The method according to claim 55, wherein a format of the DCI allocating the radio resource that is received within the reduced search space is implicitly the indication that the reduced processing time is operational for the UE and the allocated radio resource.

57. The method according to claim 55, wherein content of the DCI allocating the radio resource that is received within the reduced search space is explicitly the indication that the reduced processing time is operational for the UE and the allocated radio resource.

58. The method according to claim 55, wherein placement of the DCI allocating the radio resource that is received within the reduced search space is implicitly the indication that the reduced processing time is operational for the UE and the allocated radio resource.

59. The method according to claim 55, wherein the DCI allocating the radio resource is the indication that the reduced processing time is to be applied and the indication is valid only on a carrier on which the DCI allocating the radio resource is received and for which the radio access node has previously configured the UE performing the method for reduced processing time operation.

60. An apparatus comprising: at least one processor; and at least one memory tangibly storing a computer program,
wherein the at least one processor is configured with the at least one memory and the computer program to cause the apparatus to
send to a user equipment (UE) an indication that reduced processing time that is associated with a reduced search space is operational for the UE, wherein the reduced search space is a sub-set of a larger search space associated with a non-reduced processing time;
send to the UE within the reduced search space downlink control information (DCI) in subframe N that allocates to the UE a radio resource; and thereafter
if the allocated radio resource is uplink, receive uplink data from the UE on the allocated radio resource in a subframe spaced from the subframe N an amount of the reduced processing time; and/or
if the allocated radio resource is downlink, send downlink data to the UE on the allocated radio resource in subframe N and receive from the UE in reply feedback signaling in a subframe spaced from the subframe N an amount of the reduced processing time.

61. The apparatus according to claim 60, wherein a format of the DCI allocating the radio resource that is sent within the reduced search space is implicitly the indication that the reduced processing time is operational for the UE and the allocated radio resource.

62. The apparatus according to claim 60, wherein content of the DCI allocating the radio resource that is sent within the reduced search space is explicitly the indication that the reduced processing time is operational for the UE and the allocated radio resource.

63. The apparatus according to claim 60, wherein placement of the DCI allocating the radio resource that is sent within the reduced search space is implicitly the indication that the reduced processing time is operational for the UE and the allocated radio resource.

64. The apparatus according to claim 60, wherein the apparatus is a radio access node, and the DCI allocating the radio resource is the indication that the reduced processing time is to be applied and the indication is valid only on a carrier on which the DCI allocating the radio resource is sent and for which the radio access node has previously configured the UE for reduced processing time operation.

65. The apparatus according to claim 60, wherein the processing time is defined in terms of subframes and/or transmission time intervals, the non-reduced processing time is equivalent to a length of four subframes and/or transmission time intervals and the reduced processing time is equivalent to a length of less than four subframes and/or transmission time intervals.

66. The apparatus according to claim 60, wherein the reduced processing time is a first value if the allocated radio resource is uplink and the reduced processing time is a different second value if the allocated radio resource is downlink.
